(19) United States
(12) Patent Application Publication
(10) Pub. No.: US 2014/0215772 A1
(43) Pub. Date: Aug. 7, 2014

(54) CONNECTING ELEMENT

(71) Applicant: Dieter Ramsauer, Schwelm (DE)

(72) Inventor: Dieter Ramsauer, Schwelm (DE)

(21) Appl. No.: 14/128,034

(22) PCT Filed: Jun. 22, 2011
(86) PCT No.: PCT/EP2011/003081

§ 371 Date: Feb. 19, 2014

(51) Int. Cl. F16B 5/06

(52) U.S. Cl. CPC F16B 5/06; F16B 2005/0678
USPC 24/457

(57) ABSTRACT

A connection element including a head with adjoining neck with a rectangular outer cross section to be received in a clip-like manner such that it is secured with respect to rotation, and possibly displacement, in an opening in a. thin wall. The connection element also includes a base, from which emerge two legs extending back to the neck and having grooved foot bottoms for support on an edge of the wall opening, The head comprises a rectangular plate in which there is possibly located a slot for receiving a flat cable or for receiving a cable strip. Alternatively, the head may include a hinge part, a handle, a hook, or some other fitting part.

The present application claims priority from PCT Patent Application No. PCT/EP2011/003081 filed on Jun. 22, 2011, the disclosures of which id incorporated herein by reference in its entirety.

### FIELD OF THE INVENTION

The invention is directed to a connection element for securing a holder for a pipe or cable or cable bundle or for securing an actuating rod or a hinge part or a handle or hook or other fitting in a rectangular opening or undercut slot of a first thin wall or of a first aluminum profile, this connection element comprising a head with adjoining neck with rectangular, particularly square, outer cross section to be received in a clip-like manner such that it is secured with respect to rotation and possibly with respect to displacement in a rectangular opening in the thin wall such as a sheet metal angle or to be received in a clip-like manner such that it is secured with respect to rotation in the slot in the profile.

It is noted that citation or identification of any document in this application is not an admission that such document is available as prior art to the present invention.

Document DE 603 01 994 T2 is considered as prior art provided for round holes, meaning that fixation between the one round hole necessitates a second hole at a distance thereto for fixing with respect to rotation. It is also disadvantageous that the known plastic rivet comprises more than one part.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

Accordingly, it is the object of the invention to provide a plastic rivet or connection element which does not have these disadvantages.

The above-stated object is met by a base from which emerge two legs extending back to the neck, having grooved foot bottoms for support on the edge of the wall opening of the one plate or the undercut of the slot of the one profile, the head comprising a rectangular plate in which there is possibly located a slot for receiving a flat cable or for receiving a cable strip or, alternatively, comprising a hinge part, a handle, a hook or some other fitting part.

The connection element formed in this way is suitable for many types of application, for example, for a cable strip holder comprising a receptacle, as neck with rectangular outer cross section to be received in a rectangular opening in a thin wall of the plate so as to be secured against rotation and displacement, the head being formed of rectangular plate, while a slot is located at the neck for receiving a flat cable or for receiving a cable strip.

Two antler-like projections which can be connected to one another at the free end for enclosing a cable bundle can emerge from the rectangular plate from two opposing sides thereof.

It is advantageous when the neck with the rectangular cross section has a length such that it projects through the opening in a thin wall in working position and partially reaches into the opening of the other thin wall. In this way, the two sheet metals cannot rotate relative to one another or relative to the connection element and can accordingly be clamped in a secured position of the location secured in a rectangular cross section.

According to yet another embodiment form, the neck also projects along a portion of its extension through the opening of the other thin wall and accordingly prevents a rotation of the two thin walls relative to one another and relative to the connection element.

In case of the longer neck extension, corresponding foot areas can be provided.

It is advantageous when two areas with a lengthened neck and shortened foot are diametrically opposed.

Alternatively, two areas with a lengthened neck and shortened foot can be diametrically opposed. When the middle web of the connection element is split, this allows lateral slippage.

An eye with a bore hole can also be provided next to the base of the connection element, preferably between two connection elements, for guiding a fastening screw, particularly a screw with a self-cutting profile.

A connection element can be provided for fastening the handle by its ends.

The head can form a plate with a hook.

Alternatively, the head can be a plate with an undercut strip.

The head can also be a plate with a hinge part fitted thereto.

Finally, the neck can have a length which facilitates mounting in the undercut slot of an aluminum profile.

### BRIEF DESCRIPTION OF THE DRAWINGS

FIGS. 1A to 1E show different views showing the steps for assembling a cable strip holder according to the invention;

FIGS. 1F to 1H show enlarged views of a cable strip holder according to the invention;

FIGS. 2A, 2B and 2C show a front view, a side view and a perspective view of a cable holder of the connection element which is used according to FIG. 1;

FIGS. 3A, 3B and 3C show different views of a connection element with alternative supporting surface;

FIGS. 4A, 4B and 4C show corresponding views of a strip holder;

FIGS. 5A, 58 and 5C show a U-shaped embodiment form of the connection element;

FIGS. 6A, 6B and 6C show a connection element with supporting surface with high edge;

FIG. 7A shows a perspective view of a cable holder in which the connection element according to the invention is inserted;

FIG. 7B shows a front view of a cable holder in which the connection element according to the invention is inserted;

FIG. 7C shows a side view of a cable holder in which the connection element according to the invention is inserted;

FIG. 7D shows a top view of a cable holder in which the connection element according to the invention is inserted;

FIG. 8A shows a perspective view of a connection element according to FIG. 8B connected to a cable strip;

FIG. 8B shows a front view of a connection element connected to a cable strip;

FIG. 8C shows a side view of a connection element according to FIG. 8B connected to a cable strip;

FIG. 9A shows a perspective view of a cable holder and two metal plates which serve as connection element and which are provided with openings, and the connection process;

FIG. 9B shows a front view of a cable holder and two metal plates which serve as connection element and which are provided with openings, and the connection process;

FIG. 9C shows a plan view of a cable holder and two metal plates which serve as connection element and which are provided with openings, and the connection process;

FIG. 10A shows a front view of an embodiment form with expanded working area;

FIG. 10B shows a side view of an embodiment form with expanded working area;

FIG. 10C shows a view from both sides of an embodiment form with expanded working area;

FIGS. 11A to 11C show a front view, a side view and a perspective view of another embodiment form of a connection element;

FIG. 12A shows a perspective view of the embodiment form according to FIGS. 10A to 10C in various stages of assembly;

FIG. 12B shows a perspective view of the embodiment form according to FIGS. 10A to IOC in various stages of assembly;

FIG. 12C shows a sectional view through the embodiment form according to FIGS. 10A to 10C in various stages of assembly;

FIG. 13A shows a front view of a modified embodiment form of the connection element with grooves;

FIG. 13B shows a side view of a modified embodiment form of the connection element with grooves;

FIG. 13C shows a perspective view of a modified embodiment form of the connection element with grooves;

FIGS. 14A, 14B and 14C show views analogous to FIGS. 13A to 13C but with kinematic reversal of the projections and notches;

FIG. 15A shows a front view of a connection element for a cable bundle, a pipe or hose or a rod;

FIG. 15B shows a side view of a connection element for a cable bundle, a pipe or hose or a rod;

FIG. 15C shows a perspective view of a connection element for a cable bundle, a pipe or hose or a rod;

FIGS. 16A and 16C show a perspective view of a connection element to be used as handle;

FIG. 16B shows a side view of a connection element to be used as handle;

FIG. 17A shows a perspective view of a clothes hook as connection element;

FIG. 17B shows a cross-sectional view of a clothes hook to be used as connection element;

FIGS. 17C and 17D show identical views of another embodiment form of the clothes hook;

FIGS. 18A and 18B show two views of web-shaped connection element;

FIGS. 19A to 19C show the construction of a hinge, wherein, according to FIG. 19A, one hinge part is mounted in a thin sheet metal sheet with a rectangular opening, wherein the other hinge part is arranged in an opening in a thin wall in a similar manner resulting in a sheet metal cabinet, illustrated in FIG. 19A, in which a hinge or the like can be folded out. The holding element can extend linearly in a wide area, which is advantageous in some applications;

FIGS. 20A to 20C show views of a hinge part similar to FIGS. 19A to 19C according to the invention;

FIGS. 21A to 21C show views similar to FIGS. 20A to 20C of a hinge of similar construction;

FIGS. 22A to 22C show an assembled hinge formed of connection elements according to the invention, wherein two sheet metal walls are connected to one another by the hinge;

FIGS. 23A to 23C show a hinge for articulating a thin wall at an aluminum profile and additional fastening with a head boring screw; and

FIGS. 20A to 24D show a further example showing how a thin wall can be arranged at an aluminum profile by means of the connection element according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

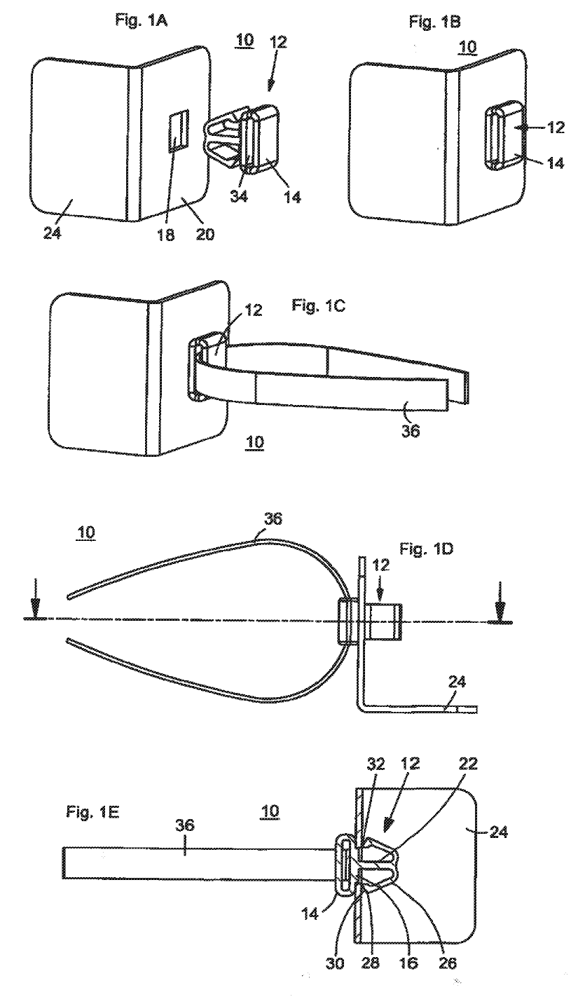

FIGS. 1A to 1E show a cable strip holder 10 comprising a connection element 12 which has a head 14 with adjoining neck 16 with rectangular outer cross section to be received in operation so as to be secured against rotation and displacement in a rectangular opening 18 in a thin wall 20 such as a sheet metal angle 24 and with a plate-shaped base 22 from which emerge two legs 26 extending back to the neck, which legs merge into feet 28 with a foot bottom 30. The head 14 comprises a rectangular plate 34 in which there is a slot 35 for receiving a flat cable or for receiving a cable strip 36.

The assembly of the arrangement according to FIGS. 1A to 1E is carried out, for example, such that the sheet metal angle is initially fastened to the housing by angle portion 24. According to the invention, the connection element 12 is pushed with its legs through the opening 18 into the other angle, wherein the legs yield and can be pushed through the opening 18 with the results illustrated in FIG. 1B, The cable strip 36 is then drawn through the slot 34 as is shown in FIG. 1C. This arrangement is shown in detail in FIG. 1D and again in a sectional view in FIG. 1E.

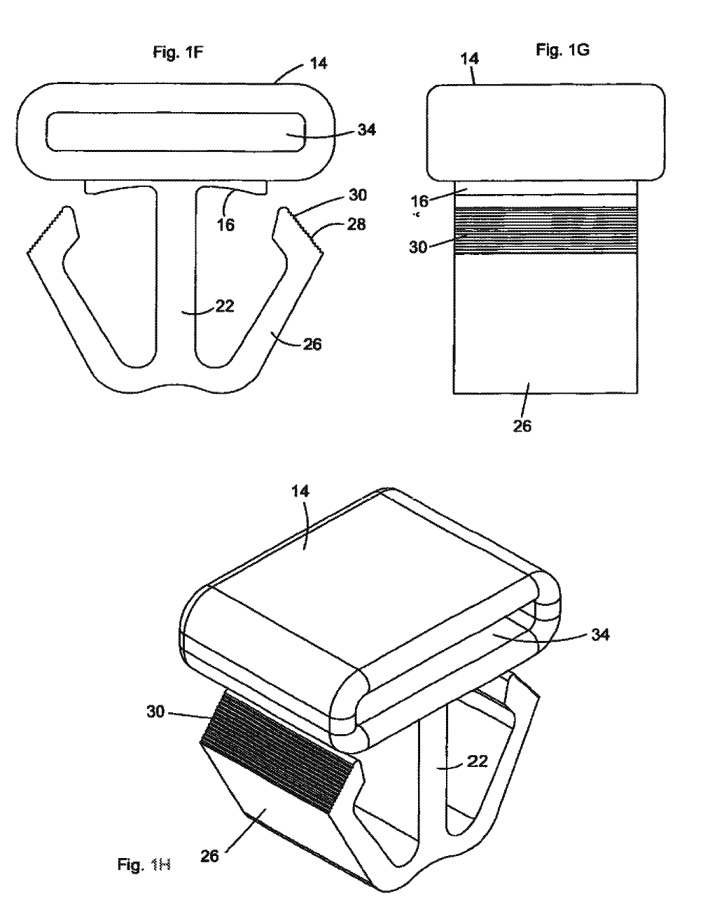

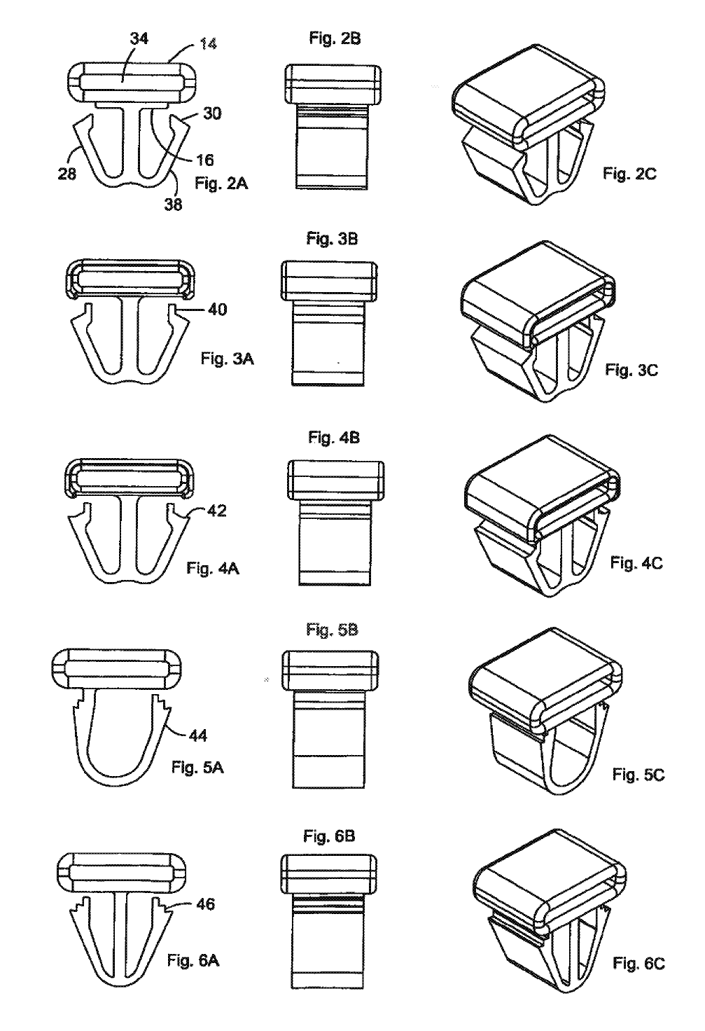

The connection element 12 used in the arrangement shown in FIGS. 1A to 1D is illustrated in detail in FIGS. 2A, 2B. Possible play is absorbed in that the foot bottom extends in a slanted manner with respect to the thin wall. The four-cornered shape of the projection 16 is also important. It prevents rotation of the connection element with respect to the opening according to FIG. 2A.

The rectangular neck 16 shown in FIG. 2A fits snugly into the openings 18 of the thin wall so as to reliably secure against rotation. The slanted surface 26 of the feet 28 facilitates insertion of the legs into the opening.

FIGS. 3A, 3B and 3C show an alternative embodiment form in which the neck 16 is omitted and, instead of this, toes 40 are arranged at the feet so as to contact the edges of the opening. In the embodiment form in FIGS. 4A, 4B, 4C, the foot additionally has a hook surface 42.

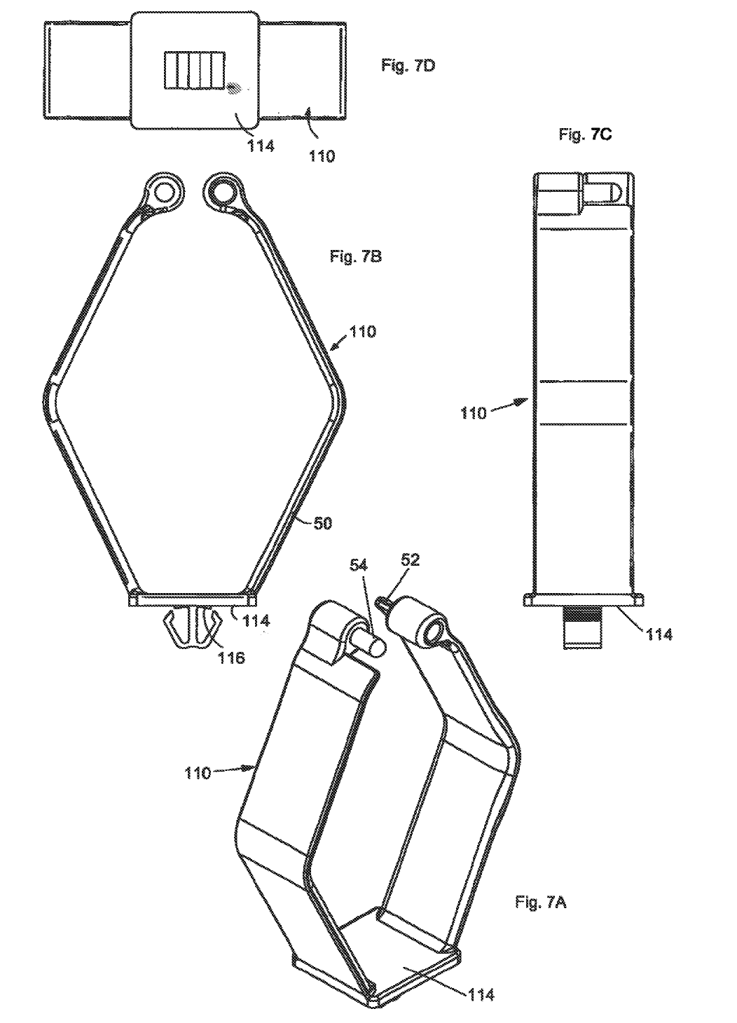

In the embodiment form according to FIGS. 5A, 5B, 5C, the antler-like projection is omitted. Instead, the one leg is fixedly connected to the head, while the other leg 44 swings freely. Finally, referring to FIGS. 6A, 6B, 6C, a jagged supporting surface 48 is provided. FIGS. 7A to 7D show a body in which two opposing sides emerge from the rectangular plate 114 of the head in the manner of antlers, and projections at the free end thereof can be connected to one another to enclose a cable strip. The connection of the free ends can be carried out by means of a plug-in connection 52, 54.

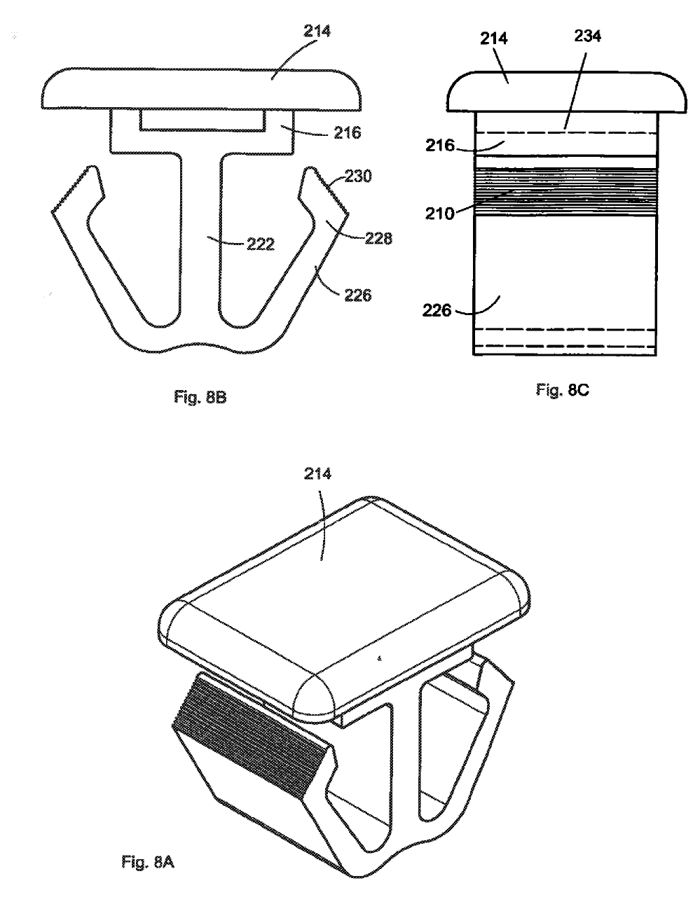

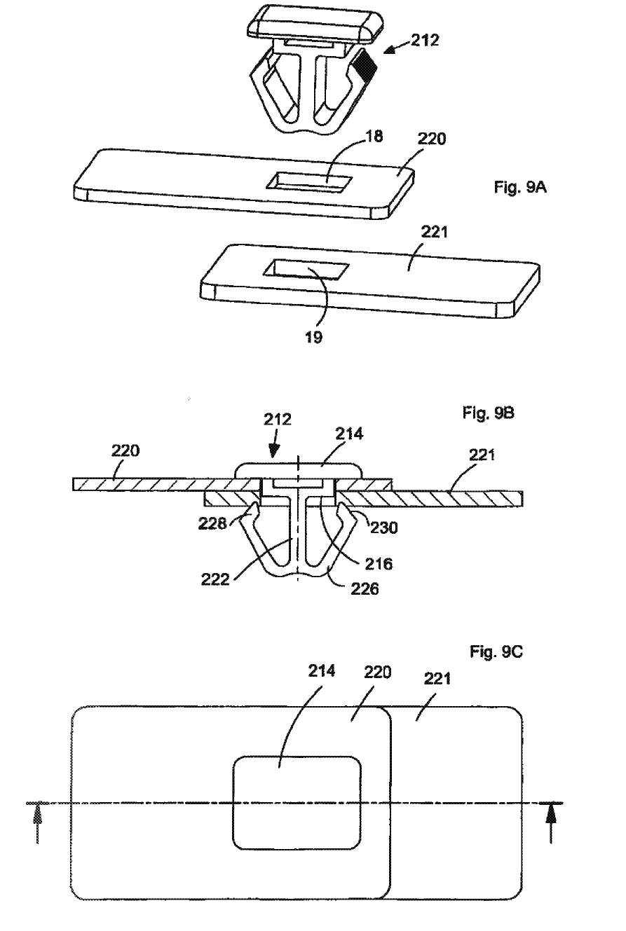

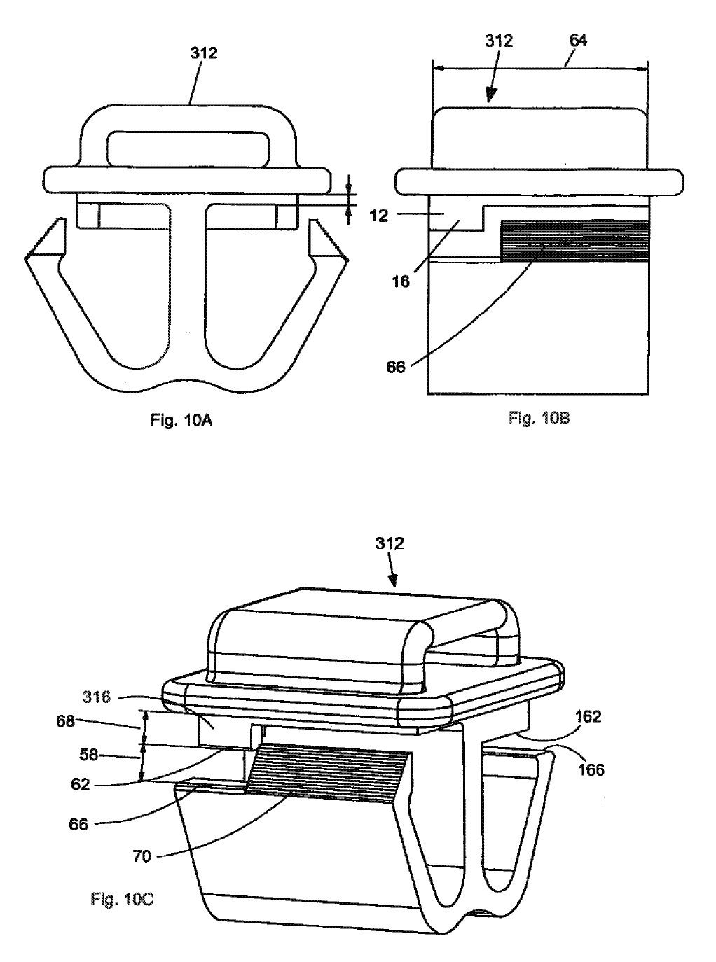

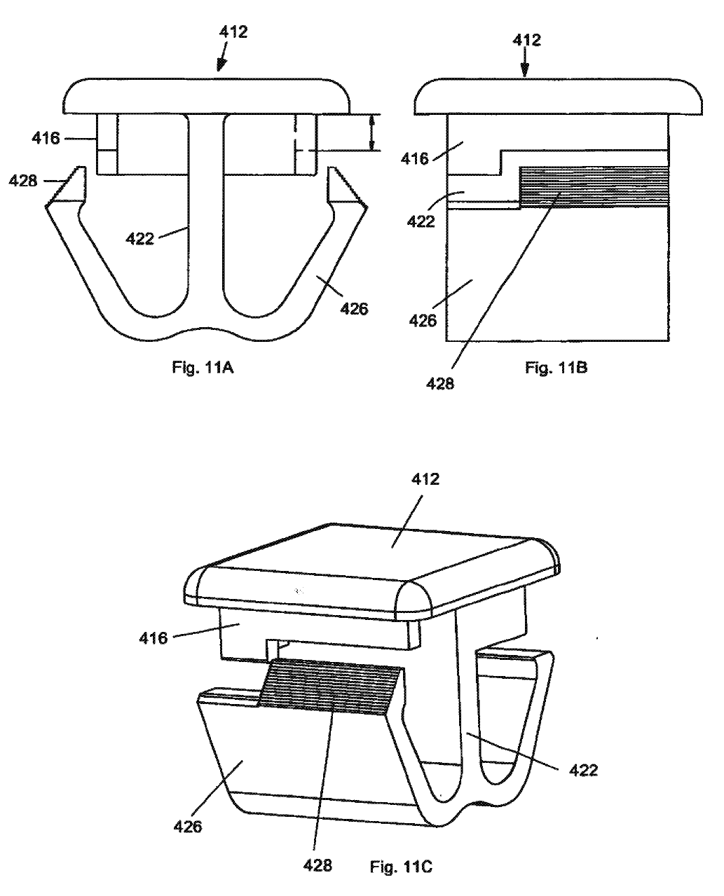

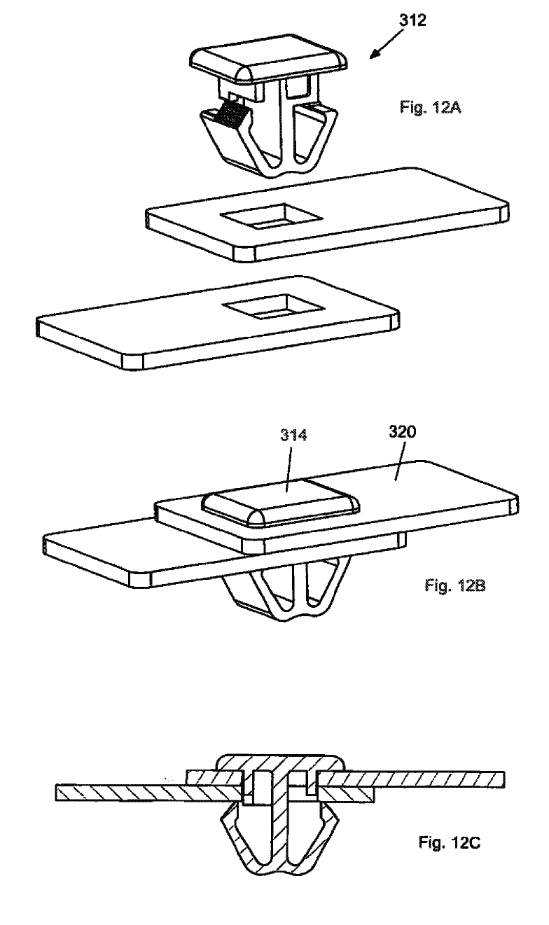

In the embodiment form according to FIGS. 8A to 8C and 9A to 9C, the rectangular neck 216 slides only through plate 220 and partially into the opening 19 of the other thin wall 221 such that the openings are aligned. For example, a rotation of the connection element 212 with respect to the two thin walls 220, 221 and the thin walls 220, 221 relative to one another is prevented.

The aim of arranging the feet 228 as close as possible to the neck area 216 results in the arrangement shown in FIGS. 9A to 9C. However, this sacrifices the security of holding walls at the ends also, because the edge of the thin walls is visible in an unsightly manner. A further development shown in FIGS. 10A, 10B and 10C is advantageous for this reason. As can be seen, the neck 316 is shortened with respect to its axial length 68 in all of the areas of the larger foot extension 70 so that the foot area 66 is free to lie on the edge of the opening, while the neck 316 secures against rotation. In this respect, there are different options for distributing these areas 62, 70. In FIGS. 10A, 10B, 10C and 11A, 11B, 11C, the arrangement is asymmetrical and has the advantage that the injection dies are simplified.

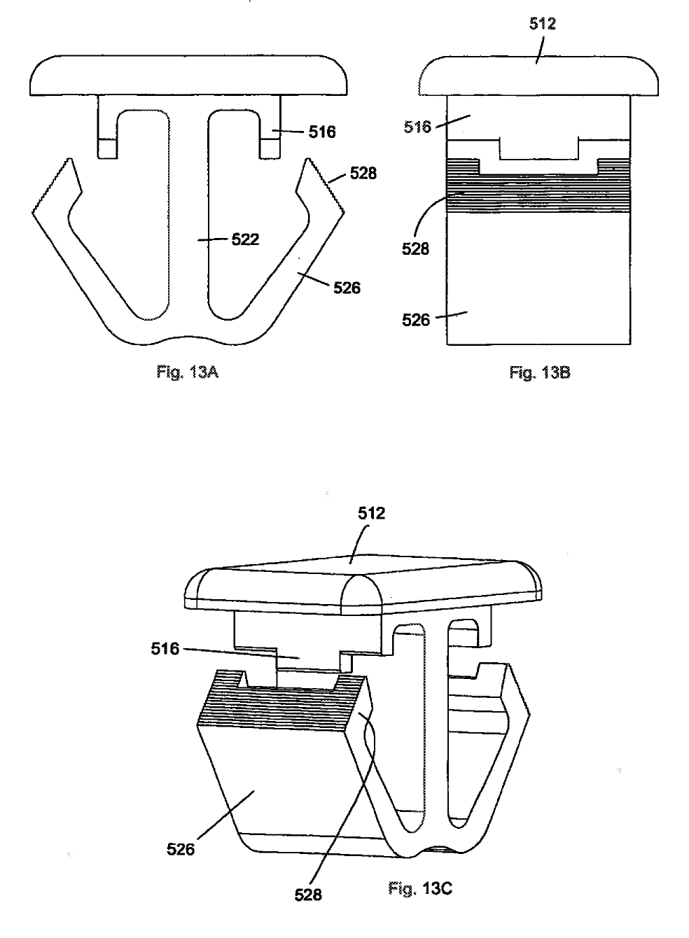

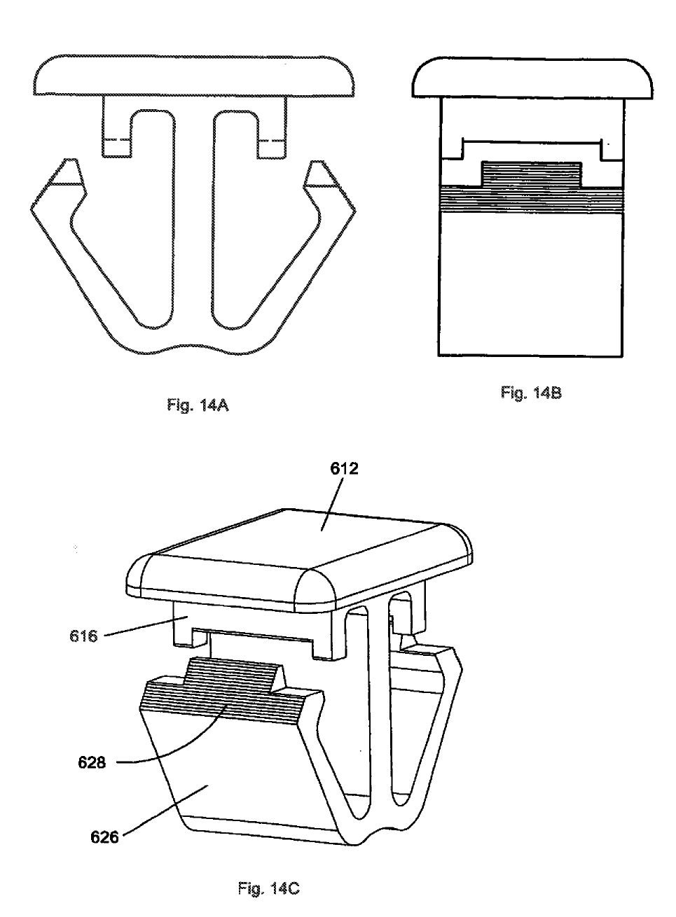

In the embodiment forms according to FIGS. 13A to 13C and 14A to 14C, the arrangement is symmetrical but more difficult to produce by injection molding because the injection mold must work with slides.

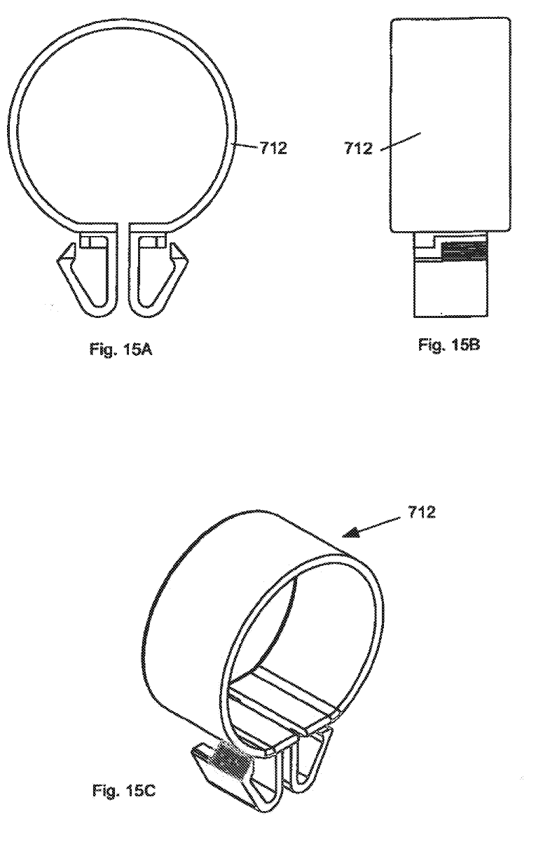

FIGS. 12A, 12B, 12C show how the arrangement is used to connect two sheet metal sheets and requires a longer neck (see FIGS. 14A to 14C), while an embodiment form to be applied as cable holder requires a short neck (see FIGS. 15A to 15C).

Further, a retaining loop for a cable bundle, a pipe, a hose or a rod which can be inserted laterally is shown in a perspective view in FIG. 15C, in a side view in FIG. 15B and in a sectional view in FIG. 15A.

With the connection element according to the invention it is possible to fasten any parts to a sheet metal wall so as to be secured against rotation such as, for example, a clothes hook which is shown in FIGS. 17A to 17D in perspective view and in a side view prior to assembly and after assembly. Another example is a handle strip 410 which can be constructed as shown in FIGS. 18A and 18B. Another use of the connection element for four-cornered or rectangular holes offers the further advantage that the legs only engage behind two opposing edges of the hole so that trim, aluminum profiles provided with slots and the like can also be fastened.

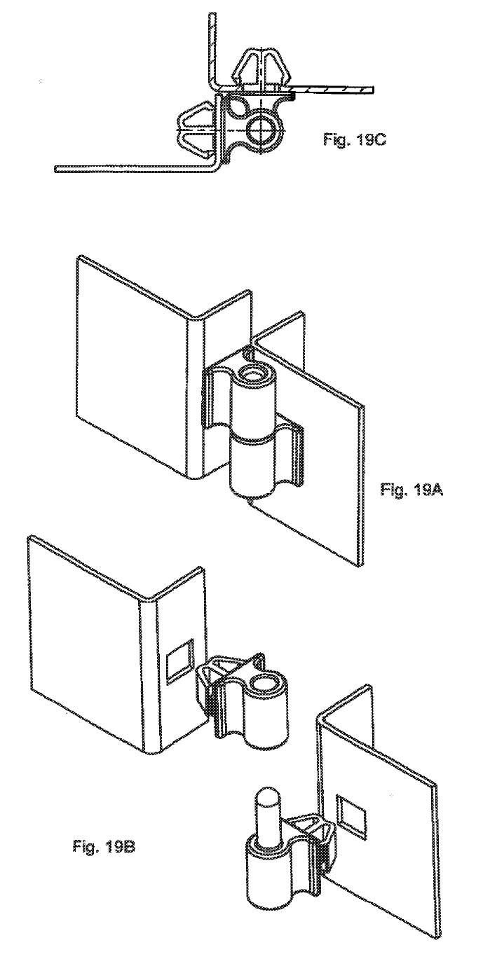

Further applications according to the invention are shown in FIGS. 19A to 19C in which the hinge parts of a hinge which have the fastening device according to the invention can be secured in a rectangular opening in a beveled sheet metal sheet (see also FIGS. 20A to 20C), wherein two holding elements 12, 112 for each hinge part are spaced apart such that a securing screw 70 can be provided, in which case this securing screw 70 has eyes 72 for a self-cutting screw 70 which are arranged between two connection elements 12, 112 according to the invention.

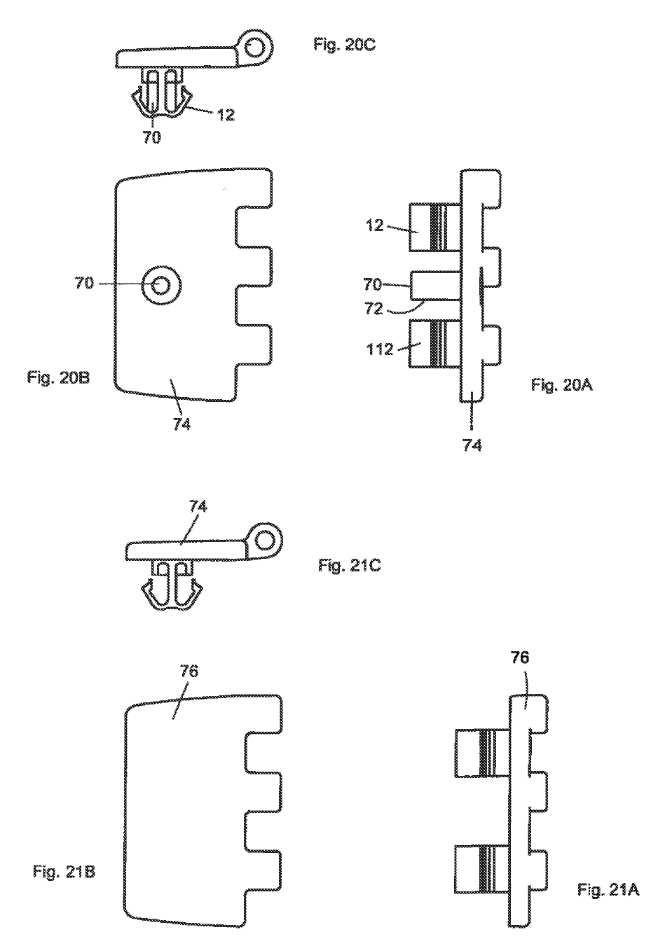

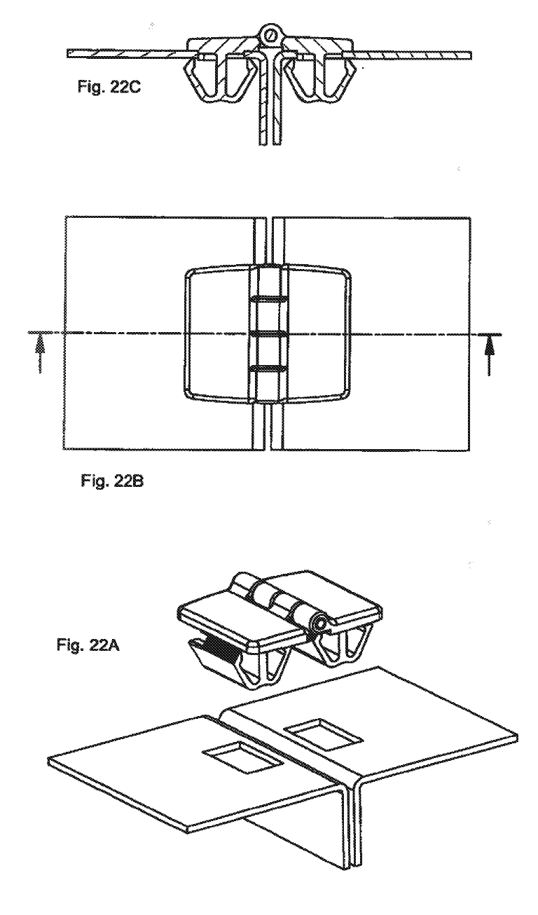

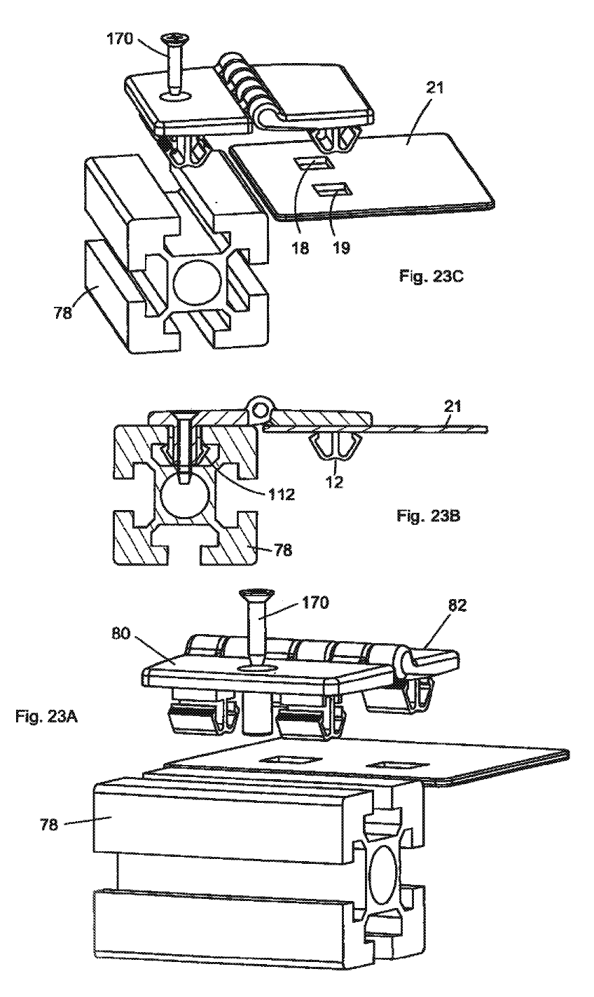

FIGS. 21A to 21C also show a hinge.

FIGS. 22A to 22D also show a hinge in which the two hinge parts according to the invention can spread apart in axial direction parallel to the hinge axis.

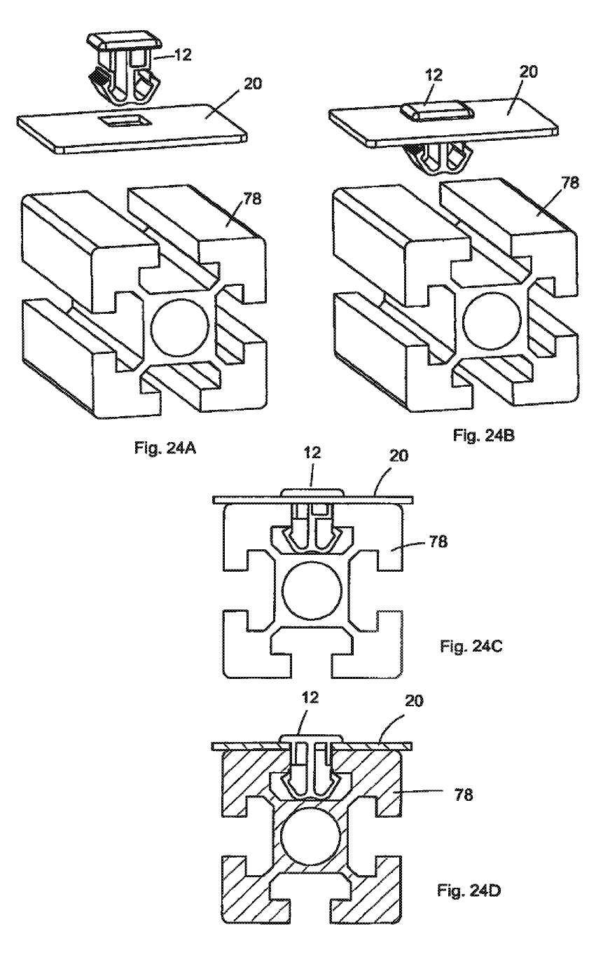

The hinge in FIGS. 23A to 23C is similar to the hinge already shown in FIGS. 21A to 21C in which a securing screw 170 which works itself into the material of a profile is arranged between two connection elements 12, 112. The one hinge half is then anchored in an aluminum profile, while the other hinge part 82 is fastened with two openings 18, 19 in a sheet metal wall 21 with holding elements 12, 112 according to the invention.

Finally, FIGS. 24A to 24B show the fastening of a sheet metal sheet 20 to profiles 78, wherein holding elements 12 according to the invention serve as fastening means.

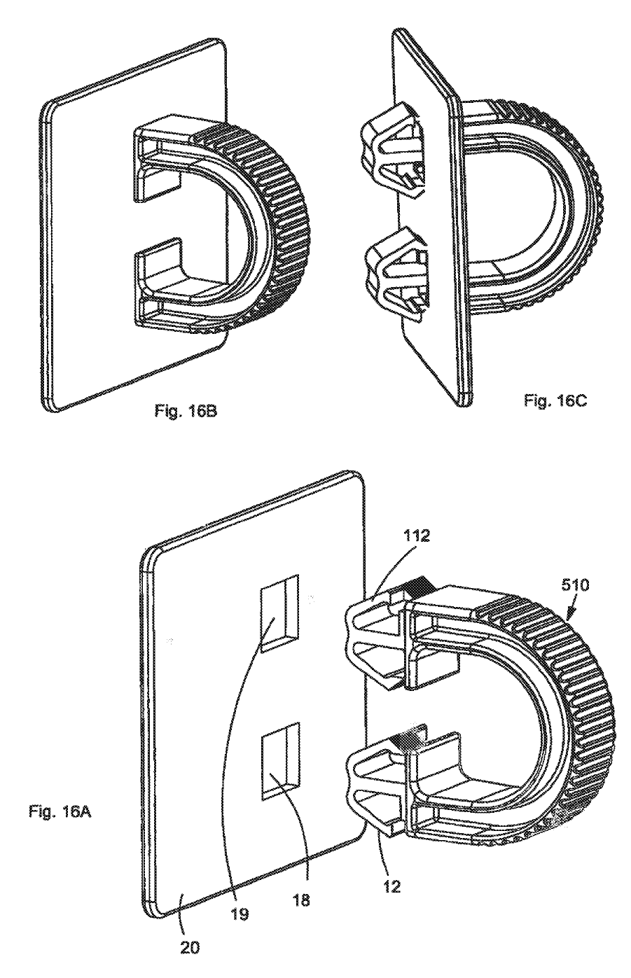

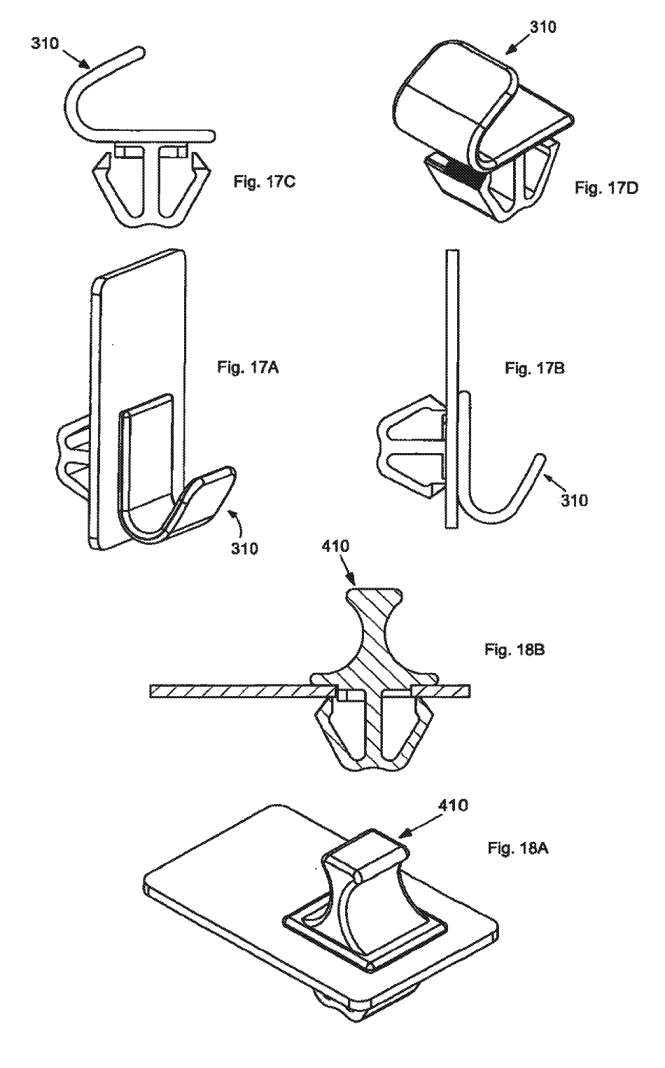

The arrangement of the finger grip without plate according to FIGS. 16A to 16C requires two holes 18, 19, wherein fastening means can be provided at the ends of the grip.

### COMMERCIAL APPLICABILITY

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### LIST OF REFERENCE NUMERALS

10, 110, 310, 410, 510 cable strip holder, clothes hook, handle strip, finger grip
12 connection element
14 head
16 neck
18 opening
19 opening
20 thin wall
21, 221 thin wall
22 plate-shaped base
24 sheet metal angle
26 legs
28 feet
30 feet bottoms
32 edge
34 slot
36 cable strip
38 bevel
40 toe
42 hook
44 free leg
46 stair shape
50 antler-like projections
52, 54 plug-in connection
56 retaining loop
58 area
60 foot area
62 portion
64 transverse extension
66 foot area
68 area length
70 securing screw
72 eye
74 hinge part
76 hinge part
78 aluminum profile
79 foot extension
80 hinge part
82 hinge part

1. Connection element for securing a holder for a pipe or cable or cable bundle or for securing an actuating rod or a hinge part or a handle or hook or other fitting in a rectangular opening or undercut slot of a first thin wall or of a first aluminum profile, this connection element comprising a head (14) with adjoining neck (16) with rectangular, particularly square, outer cross section to be received in a clip-like manner such that it is secured with respect to rotation and possibly with respect to displacement in the rectangular opening (18) in the thin wall (20) such as a sheet metal angle (24) or to be received in a clip-like manner such that it is secured with respect to rotation in the slot in the profile, characterized by a base (26) from which emerge two legs (26) extending back to the neck (32), having grooved foot bottoms (30) for support on the edge (32) of the wall opening (18) of the one plate (20) or the undercut of the slot of the one profile, the head (14) comprising a rectangular plate in which there is possibly located a slot (34) for receiving a flat cable or for receiving a cable strip (36) or, alternatively, comprising a hinge part, a handle, a hook or some other fitting part.

2. Connection element according to claim 1, characterized in that two antler-like projections which can be connected to one another at the free end for enclosing a cable bundle emerge from the rectangular plate from two opposing sides thereof. (FIGS. 7A to 7D)

3. Connection element according to claim 1 for two thin walls (sheet metal sheets) (20, 21) provided with rectangular opening (18, 19), wherein the connection element with head (214) with adjoining neck (216) with rectangular, particularly square, outer cross section to be received such that it is secured with respect to rotation and with respect to displacement in a corresponding rectangular opening (218) in a thin wall such as sheet metal bracket or sheet metal angle and with a plate-shaped base (222) from which emerge two legs extending back to the neck, and with grooved foot bottoms (230) for support on the edge of the wall opening of the one plate, wherein the head at least includes a rectangular plate which is supported on the edge of the opening of the other thin wall. (FIGS. 9A to 9C)

4. Connection element according to claim 3, characterized in that the rectangular neck has an axial length (68) such that it projects through the opening (18) in the one thin wall (20) in working position and partially reaches into the opening (19) of the other thin wall (221) so as to prevent rotation of the connection element with respect to the first thin wall. (FIGS. 9A to 9C)

5. Connection element according to claim 4, characterized in that the neck also projects along a. portion (62) of its cross-sectional extension (64) through the opening of the other thin wall and accordingly prevents a rotation of the two thin walls relative to one another and relative to the connection element. (FIGS. 10A to 10C)

6. Connection element according to claim 5, characterized in that in the area of the lengthened neck extension (56), the corresponding foot area (66) is shortened. (FIGS. 10A to 10C)

7. Connection element according to claim 6, characterized in that two areas with lengthened neck and shortened foot are diametrically opposed.

8. Connection element according to claim 6, characterized in that two times two areas (62, 66; 162, 166) with lengthened neck and shortened foot are diametrically opposed. (FIGS. 10A to 10C)

9. Connection element according to claim 1, characterized in that the middle web of the connection element is split to permit lateral slippage. (FIGS. 15A to 15B)

10. Connection element according to claim 1, characterized in that an eye is provided next to the base of the connection element, preferably between two connection elements, for guiding a fastening screw, particularly a screw which cuts a thread into an aluminum profile. (FIGS. 20A to 20C) (FIGS. 23A to 23C)

11. Connection element according to claim 1, characterized in that a connection element is provided for fastening a handle with two handle ends. (FIGS. 16A to 16C)

12. Connection element according to claim 1, characterized in that the head forms a plate with a hook-shaped projection. (FIGS. 17A to 17C)

13. Connection element according to claim 1, characterized in that the head is a plate with an undercut head or strip. (FIGS. 18A to 18C)

14. Connection element according to claim 1, characterized in that the head is a plate with a hinge part fitted thereto. (FIGS. 21A to 21C) (FIGS. 22A to 22C)

15. Connection element according to claim 1, characterized in that the neck has a length which facilitates mounting in the undercut slot of an aluminum profile. (FIGS. 24A to 24D)
